(19) United States
(12) Patent Application Publication
(10) Pub. No.: US 2004/0217012 A1
(43) Pub. Date: Nov. 4, 2004

(54) Process and device for the galvanic surface treatment of work pieces

(76) Inventor: Gerhard Gramm, Ditzingen (DE)

Correspondence Address: WILLIAM ANTHONY DRUCKER, Suite 800, 1901 L Street, N.W., Washington, DC, 20036-3506, US

(21) Appl. No.: 10/775,814

(22) Filed: Feb. 9, 2004

Related U.S. Application Data
(63) Continuation of application No. PCT/EP02/08173, filed on Jul. 23, 2002.

(30) Foreign Application Priority Data
Aug. 10, 2001 (DE) 101 40 934.6

(51) Int. Cl. C25D 17/00; B23H 3/00

(52) U.S. Cl. 205/640; 204/224 M

(57) ABSTRACT

A process and a device for the galvanic surface treatment of work pieces are disclosed. The device comprises a closed process chamber wherein a work piece is received, the work piece having at least one surface exposed toward the process chamber. A process fluid is fed via inlet openings into the process chamber and is removed via outlet openings from the process chamber. At least one electrode is provided that is connected to a DC power source, while the work piece is connected to the opposite pole of the power source. The process fluid is pumped through the process chamber along a surface to be treated, while a plurality of inlet openings and outlet openings are arranged in an alternating configuration in a common surface opposite the treatment surface.

### RELATED APPLICATIONS

This application is a continuation application of International Patent Application PCT/EP02/08173 which claims priority of German patent application 101 40 934.6.

### BACKGROUND OF THE INVENTION

The invention relates to a device and to a process for the galvanic surface treatment of work pieces within a closed process chamber through which galvanic treatment fluid is fed while a DC current is induced between the work piece and an electrode arranged in fluid communication with the first surface to be treated.

European patent 0 445 120 discloses a process and device for the galvanic surface treatment of one or more work pieces within a process chamber. The work pieces are introduced into the process chamber and can be treated galvanically by the process fluid which is fed by a suction pump into the process chamber at a relatively high rate. Within the process chamber a stirring device is provided to facilitate a homogenous treatment of the work piece surface.

In the galvanic surface treatment of mass production parts, such as in the treatment of cylinder faces of internal combustion engines, the treatment time shall be as short as possible while a high quality, and in particular homogeneity of the treated surface is required. To shorten the process time and to ensure an even quality of the treated surface it has been tried to guide the process fluid along the surface to be treated within a closed process chamber at high turbulence.

According to German patent 37 42 602 to this end an electrolyte carrying the material to be deposited is guided to the outer surfaces of an anode arranged centrally along the cylinder axis, and an electrolyte is introduced into the cylinder by means of a current guide body generating current spin, wherein the current divides into a laminar part and into a turbulent part. However, it has been found to be disadvantageous that even in view of the turbulence that is generated, the cylinder bores are coated unevenly.

According to U.S. Pat. No. 4,376,683 a method and device for the partial galvanization of a surface of a conductive material is disclosed. A flow-on channel and a flow-off channel are positioned at an angle relative to the surface at less than 45° and arranged to direct the electrolyte solution at an angle onto the surface to be treated. The electrolyte is removed at an angle to the surface by the flow-off channel such that on the surface to be treated a substantially laminar flow shall arise. The flow-on channel and flow-off channel are constructed of a corrosion-resistant material. A metallic anode element is arranged in at least one of the flow-on and flow-off channels adjacent the area to be treated.

This arrangement suffers from the drawback that only small surfaces in the vicinity of the flow-off channel and flow-on channels can be treated. A homogenous treatment of a larger surface of the work piece is not made possible.

U.S. Pat. No. 3,592,753 discloses a magnetic plating cell comprising a perforated sleeve structure adapted to uniformly distribute the flow of magnetic plating electrolyte past a wire substrate according to a prescribed uniform, substantially transverse agitation mode along the plating length of a continuously moving wire so that a thin magnetic film may be plated thereon under high current density/high agitation conditions. The wire to be plated at the outer surface is continuously moved along a channel through which the plating solution is fed transversely through inlet openings on one side of the channel and outlet openings on the opposite side of the channel. The plating solution flows from each inlet channel around the wire to the outlet channel on the opposite side.

This device is particularly suited for the coating of a wire on its outer side.

### SUMMARY OF THE INVENTION

It is a first object of the invention to provide a device for the galvanic surface treatment of work pieces allowing a homogenous galvanic surface treatment of a selected surface part.

It is a second object of the invention to provide a device for the galvanic surface treatment allowing a high quality galvanic surface treatment of a work piece within a short process time.

It is a third object of the invention to provide a device for the galvanic surface treatment allowing a homogenous treatment of a relatively large surface of a work piece.

It is a further object of the invention to provide a device for the galvanic surface treatment of work pieces particularly adapted for the high quality surface treatment of work pieces undergoing considerable load during operation.

It is a further object of the invention to provide a process for the galvanic surface treatment of work pieces allowing a high quality surface treatment of selected inner or outer surfaces of a work piece.

These and other objectives of the invention are solved by a device for the galvanic surface treatment of work pieces which comprises a holder for receiving the work piece by which a closed process chamber comprising at least one exposed surface of the work piece is formed. The holder comprises at least two parts that are movable with respect to each other to receive the work piece and to form the closed chamber wherein the galvanic treatment is performed. The closed chamber comprises a plurality of inlet openings and outlet openings that are arranged within a common surface in a pattern formed by alternating inlet and outlet openings or by groups of alternating inlet and outlet openings leading into the closed chamber. The process fluid is pumped through the inlet openings into the process chamber and is removed from the process chamber through the outlet openings. A galvanic treatment is performed by connecting the work piece to one pole of a DC power source and providing at least one electrode arranged in fluid communication with the process chamber which is connected to the other pole of the DC power source.

According to the invention it has been found that the process fluid must be supplied in close vicinity to the surface to be treated and must be removed there from after treatment also in close proximity thereto. In this way an ideally homogenous current profile can be reached with a high Reynolds' number without receiving the common current profiles encountered with rebounding currents which always carry the drawback of impact pressure. Simultaneously an optimal turbulence and removal of the generated process gases is made possible which always helps to improve the surface quality.

In addition local variations of the process fluid, of the temperature, of the density etc. are avoided which also facilitates an even treatment of the total surface to be treated.

Ideally a large number of inlet openings and outlet openings are arranged alternatingly in front of the surface of the work piece to be treated. For treating a larger surface the feed and drain openings for the process fluid may lead into the process chamber in a grid pattern opposite the surface to be treated.

If a larger number of inlet and outlet openings is utilized, also groups of inlet openings may be arranged alternatingly with groups of outlet openings. However, usually a pattern of alternating individual inlet and outlet openings is preferred.

The inlet and outlet openings preferably are of circular cross section. However they also may have an elliptical, an oval, a rectangular or a different cross section.

In case larger surfaces must be treated, then the inlet and outlet openings are preferably shaped as rectangular openings connected with slit-shaped channels.

According to a further development of the invention the electrode is designed as a longitudinal hollow body or tube-shaped body which comprises at least one feed channel and at least one drain channel, wherein the feed channel is in fluid communication with a plurality of inlet openings which cooperate with outlet openings in fluid communication with the drain channel.

Such a device is particularly suited for the galvanic treatment of inner surfaces of work pieces, such as cylinder faces. Instead of the common fluid flow of a ring-shaped gap between a bar to be treated and a car arranged therein, now bars of any length desired and also cavities bent in longitudinal direction can be treated evenly, since the process fluid fed by an inlet opening is removed by an outlet opening in the vicinity thereof. Depending on the number of inlet openings and outlet openings thus the longitudinal lance-shaped hollow body is segmented longitudinally into a large number of virtual disks arranged behind each other which each have individual inlet and outlet openings.

Thus local variations of the process fluid, of the temperature, the density etc. are avoided and simultaneously.an optimal turbulence and removal of the gases that are generated is made possible. In this way also very long inner surfaces of work pieces may be treated very evenly at high quality.

According to a further embodiment of this development the electrode may be designed as a separating wall between the feed channel and the drain channel.

This feature offers the advantage that the necessary separation of the longitudinal cavity into at least one feed channel and one drain channel is reached in a particularly simple way while simultaneously providing the electrode at a certain distance (separated by the surrounding casing) from the process chamber. Since the process gases during galvanic treatment are usually generated in close proximity to the electrode, the gases are directly removed, before they enter into the actual process chamber.

This embodiment may even be further improved by providing gas passages extending between the feed channel and the drain channel. For instance the electrode designed as the separating wall may carry a thin perforation. In this way gases generated in the region of the inlet openings may be directly removed by a vacuum generated in the adjacent drain channel, thus ensuring a good removal of the process gases which leads to an improved surface characteristic of the treated surface and also allows for higher current densities and shorter process times.

The hollow body is preferably enclosed by a casing made of an insulating material. Thereby the electrode is arranged at a certain distance from the process chamber which allows to better remove the process gases that are generated.

According to a further embodiment of the invention for the treatment of outer surfaces of work pieces along an inner surface of the process chamber a plurality of inlet openings and outlet openings are arranged in front of the surface to be treated in an alternating pattern or grid.

The inlet openings and outlet openings are formed at the end of feed and drain channels which may be arranged at certain angles with respect to the surface to be treated to optimize the surface treatment. The feed and drain channels may be in fluid communication with at least one common channel each, thus allowing a large plurality of inlet and outlet openings through which a process fluid is guided. Also with this embodiment, which is particularly suited for the surface treatment of an outer surface of a work piece, the electrode may be arranged outside the process chamber at a certain distance from the inlet and outlet openings but in fluid communication with the process chamber.

In this way the process gases that are generated can be removed effectively which helps to improve the quality of the surface treatment while allowing for higher current densities.

According to a further development of the invention at least a certain portion of the feed channels are arranged at an angle different from 90° with respect to the surface to be treated. In particular the feed channels may form acute angles with the surface to be treated, thus leading to a certain flow direction of the process fluid along the surface.

Usually the drain channels are arranged substantially at an angle of 90° with respect to the surface to be treated. However, also different angles may be utilized.

When treating annular shaped outer surfaces of work pieces for instance the feed channels may preferably form an acute angle with respect to the surface to be treated, while the drain channels preferably are arranged perpendicularly with respect to the surface to be treated, thus facilitating a current flow direction via a short path along the surface to be treated starting from a feed channel and ending at an adjacent drain channel. Thus an optimal flow direction along the perimeter of the work piece to be treated can be reached.

It will be understood that these measures can also be utilized when treating inner surfaces of work pieces.

The device according to the invention preferably comprises a holder having at least two parts allowing to insert a work piece there between and to move the two parts against each other for forming a closed process chamber there between which includes the surface to be treated as an exposed surface.

In this way an automatic handling of the process chamber with a work piece is made possible by suitable handling devices.

In case an outer surface of a work piece shall be treated, then a mask that encloses the outer surface of the work piece to be treated may be provided. Within the mask the feed and drain channels may be arranged, while the process chamber may be formed between an inner surface of the mask and an outer surface of the work piece and possibly between the two holder parts.

In this way the volume of the process chamber may be kept very small which improves the evenness of the treatment. Herein the mask may also comprise the electrode.

Suitable sealing means may be provided to seal the process chamber when moving the holder parts against each other.

Preferably, the means for generating a fluid flow through the process chamber comprise a suction pump which is arranged downstream of the process chamber.

In this way the gases generated within the process chamber and the feed and drain channels are effectively removed. Also the device operates at a certain pressure below the atmospheric pressure so that it can be avoided that process fluid escapes in case of leakage. However, also a pressure pump arranged upstream of the process chamber may be utilized, if desired.

It will be understood that the above-mentioned and following features of the invention are not limited to the given combinations, but are applicable in other combinations or taken alone without departing from the scope of invention.

Further features and advantages of the invention will become apparent from the following description of preferred embodiments taking in conjunction with the drawings. However, the following description of preferred embodiments is merely of exemplary nature and shall not be understood to limit the scope of the invention.

### BRIEF DESCRIPTION OF THE DRAWINGS

FIG. 1 shows the general principle of the invention in a very simplified representation;

FIG. 2 shows a modification of the device shown in FIG. 1 which is particularly suited for the treatment of inner surfaces of a work piece;

FIG. 3 shows a cross section through the hollow body or lance according to FIG. 2 which protrudes into the center of the process chamber;

FIG. 4 shows a further development of the embodiment according to FIG. 1 which is particularly suited for the treatment of an outer surface of a work piece; and

FIG. 5 shows a modification of the embodiment according to FIG. 4 according to which only a mask is shown from the top in which the individual feed and drain channels are depicted.

### DETAILED DESCRIPTION OF THE PREFERRED EMBODIMENTS

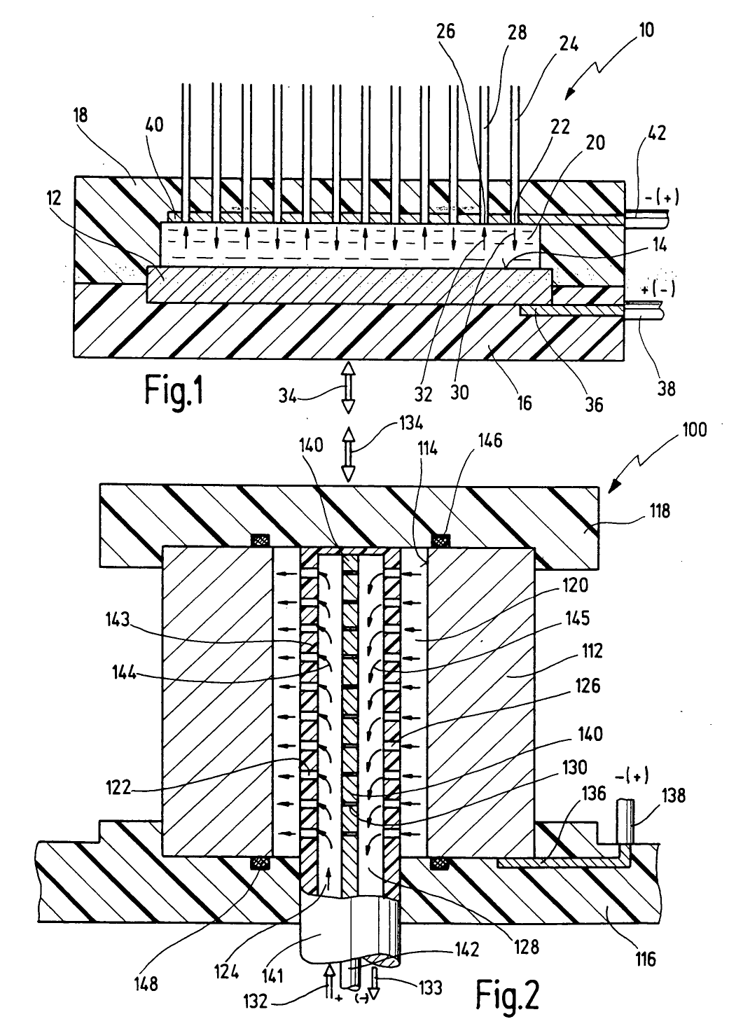

According to FIG. 1 a first simplified embodiment of the invention is shown and denoted in total with reference numeral 10.

The device 10 comprises a first lower clamping part 16 and a second upper clamping part 18 between which a work piece 12 may be clamped. To this end at least one of the clamping parts or holder parts 16, 18 may be arranged movably with respect to the other part as indicated by arrow 34.

The work piece 12 to be treated is only depicted as a cuboid part having a flat surface 14 to be treated. Above the treatment surface 14 a process chamber 20 is formed which is a cavity within the upper clamping part 18 and which is limited at the lower side by the treatment surface 14 of the work piece 12. Thus the treatment surface 14 of the work piece is exposed at its upper surface to the process chamber 20.

For electrically contacting the work piece 12 an electric contact 36 within the lower clamping part 18 is provided that can be connected to a DC power source via a line 38. The top surface of the process chamber 20 is designed as an electrode 40 which can be connected to the other pole of the DC power source (not shown) by a wire or line 42.

Within the top surface of the process chamber 20 a plurality of feed channels 24 and drain channels 28 yields via inlet openings 22 and outlet openings 26, respectively.

Herein the inlet openings 22 are arranged alternatingly with the outlet openings 26.

In case only slim long work pieces must be treated, then only a sequence of feed channels and drain channels may be arranged in a sequence. In case a larger surface of the work piece 12 shall be treated, then a plurality of inlet and outlet openings may be arranged in a grid pattern within the top surface of the process chamber 20, wherein the feed channels 24 are arranged alternatingly with respect to one or more drain channels 28. Herein different grid patterns are possible.

Also it is possible to utilize groups of feed channels and drain channels which are arranged alternatingly with each other so that groups of several inlet openings and several outlet openings are arranged alternatingly with each other. However, for treating larger surfaces it is preferred to use slit-shaped feed and drain channels 24, 28 which are arranged alternatingly with each other.

According to FIG. 1 the individual feed and drain channels 24, 18 communicate with a circuit for feeding a process fluid (not shown) whereby the process fluid is fed at relatively high velocity as indicated by arrows 30, 32 into the process chamber 20 into the direction of the treatment surface 14 and is removed by a respective drain channel 28 adjacent thereto.

For ease of representation sealings and other parts necessary to form the closed process chamber 20 are not shown in FIG. 1.

By the special arrangement of adjacent inlet and outlet openings 22, 26 arranged alternatingly with each other the galvanic surface treatment leads to a very even homogenous surface, since an optimal turbulence and removal of the process gases that are generated is made possible while an ideally homogenous current profile and a very high Reynolds' number is made possible without the typical drawbacks that occur with impinging currents.

A further advantage rests in the fact that by the fast exchange of the process fluid a high degree of process stability is reached by stable process parameters, such as the chemical structure of the process fluid, the degree of dissociation of the process fluid, the density, the temperature etc. Also this helps to improve the evenness and quality of the treatment surface. These advantages of the invention are reached independently from the type of galvanic process that is performed.

In case the work piece is connected as a cathode i.e. is connected with the negative pole of the DC power source, while the electrode is configured as an anode being connected with the positive pole of the power source, then when utilizing a suitable electrolyte as a process fluid on the treatment surface a metallic coating is deposited, since the respective metal ion salt added to the process fluid (the electrolyte) dissociates, and the positively charged metal ions travel to the cathode and are deposited thereon.

However, if the work piece is configured as an anode and the electrode is configured as cathode, then the classic process of anodic oxidation is performed i.e. oxidic protective coatings on metals are made electrolytically. This process which is well known in the treatment of aluminum and is also designated in this regard as anodizing, leads to the formation of aluminum oxide on the treatment surface which serves as an effective protective coating on the aluminum body.

Thus the polarity shown in FIG. 1 according to which the work piece 12 is configured as an anode and the electrode 40 is configured as the cathode, relates to the anodizing of the treatment surface of a work piece 12 of aluminum.

In FIG. 2 a modification of the device according to the invention is shown in longitudinal section and is designated with reference numeral 100 in total.

This embodiment is particularly preferred, if a work piece 112 shall be treated at an inner surface 114, for instance if in a cylinder bore a thin ion coating shall be deposited galvanically.

While of course it is possible to provide as many feed channels and drain channels as desired on an outer surface, since they may directly run into the process chamber, when treating an inner surface of a work piece further measures are necessary to guide the process fluid into the vicinity of the treatment surface, to feed the process fluid via inlet openings into the process chamber and to remove the process fluid via outlet openings in close proximity thereto.

To this end a device according to FIG. 2 comprises a longitudinal hollow body 141 or a lance which is inserted into the cavity of a work piece 112 to be treated, the outer contour of the lance 141 being adapted to the inner surface 114 of the work piece 112 to be treated.

While in the example shown in FIG. 2 the treatment surface 114 of the work piece 112 is formed as a cylindrical inner surface and therefore also the lance 141 is shaped as a cylinder, also the treatment of differently shaped inner surfaces of work pieces is possible when an even distance to the treatment surface with respect to the work piece is ensured.

Thus the treatment surface of the work piece might for instance be a curved inner surface, and the lance would also be curved in a corresponding manner.

However, in the example shown in FIG. 2 the work piece 112 is shaped cylindrically and is permeated by a central cylindrical bore the inner surface of which is the treatment surface 114.

The work piece 112 is clamped between a first lower clamping part 116 and a second upper clamping part 118, wherein sealing rings 146 and 148, respectively are utilized to seal the process chamber 120 formed in this way to the outside. The two clamping parts 116, 118 are arranged movable with respect to each other to allow insertion and removal of a work piece 112, as indicated by the double arrow 134.

The lance 141 protrudes through the lower clamping part 116 into the process chamber 120 and preferably rests with a closed end against the outer wall surface of the upper clamping part 118. In this way between the lance 141 and the treatment surface 114 of the work piece 12 a hollow cylindrical process chamber 120 is formed which is limited by the upper and lower surfaces of the clamping parts 116, 118 and to the outside by the treatment surface 114 of the work piece 112 and to the inner side by the cylinder jacket surface of the lance 141.

For contacting the work piece 112 the lower clamping part 116 which is generally made of insulating material comprises an electric contact 136 which can be connected via a line 138 with the negative pole of a DC power source, in case a galvanic coating of the treatment surface 114 is desired.

The electrode 140 is formed as a rectangular shaped plate which extends about the total length of the lance 141 and which divides the inner room of lance 141 into a drain channel 128 and a feed channel 124. The wall 143 of the lance 141 is made of an electrically insulating material which must be chemically resistant against the process fluid. The electrode 114 is connected to the positive pole of the DC power source via a line 142 in the case discussed here.

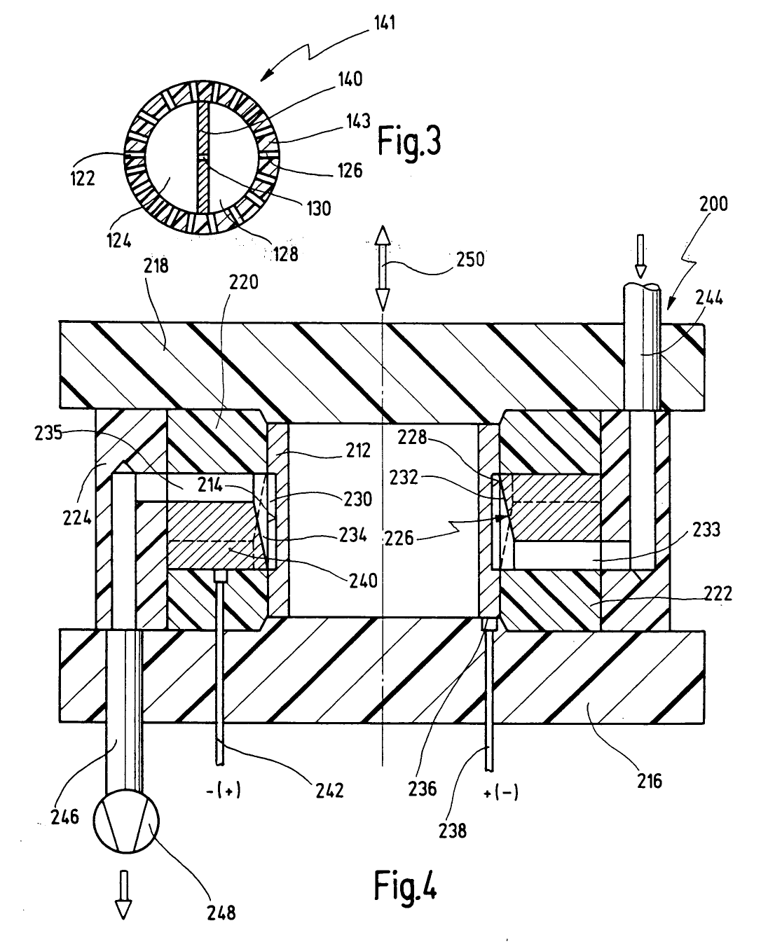

As can be seen from FIG. 2 and FIG. 3 (not drawn to scale) in the wall 143 of lance 141 a plurality of inlet openings 122 and outlet openings 126 are provided.

Herein the wall 143 of lance 141 on the side of the feed channel 124 is provided along its longitudinal extension with inlet openings 122. In a corresponding manner on the opposite side of the wall 143 corresponding outlet openings 126 are provided that communicate with the drain channel 128.

In this way in the embodiment shown in FIG. 2 at least ten inlet openings 122 are arranged at even distances from each other in axial direction of the lance 141, while on the opposite side, that is preferably displaced by 180° about the longitudinal axis of lance 141, a corresponding set of outlet openings 126 are provided.

As can be seen from FIG. 3, it is preferred, however, to provide not only one inlet opening 122 at the respective axial positions of the lance 141 communicating with the feed channel 124 and to provide a respective outlet opening 126 communicating with the drain channel 128 at the opposite side, but to provide the wall 143 instead with a plurality of inlet openings 122 on the side of the feed channel 124 and also with a plurality of outlet openings 126 on the side of the drain channel 128.

In this way along the lance 141 a plurality of inlet openings 122 are arranged at constant axial distances which are preferably displaced by even angular intervals and which cooperate with respective outlet openings 126 arranged on the opposite side of the lance 141.

In this way the lance 141 is divided into individual disk-like regions which each are provided with inlet openings 122 on the one side and with outlet openings 126 on the opposite side.

Thus independently from the axial length of the treatment surface 114 a homogenous feeding of process fluid and a homogenous removal of process fluid is made possible along the total axial extension of the treatment surface 114.

During operation the process fluid is fed into the direction of arrow 132 via the feed channel 124, emerges through the inlet openings 122 which are provided in the wall 143 on the side of the feed channel 124 in a sieve-like manner, emerges into the process chamber 122 travels around the treatment surface 114 in substantially tangential direction, until it flows through the respective outlet openings 126 into the drain channel 128 from which it is removed in the direction of arrow 133.

The process fluid itself circulates in a closed loop which is not shown in FIG. 2 and which comprises a suction pump for sucking the process fluid at high speed from a reservoir through the feed channel 124 into the process chamber 120 and through the drain channel 128, finally via a line into the same or a different reservoir (not shown).

In addition the electrode 124 may be penetrated by thin gas passages 130 such as shown in FIGS. 2 and 3.

By traveling through these gas passages 130 process gases which are generated in particular in the region of the electrode 140 may travel directly from the feed channel 124 into the drain channel 128 and may be removed together with the process fluid without coming into the actual process chamber 120. Thus it is avoided that process gases may impair the surface treatment. Since the cross section of the gas passages 130 is only very small when compared to the cross section of the inlet openings 122 and the outlet openings 126, only a small part of the process fluid travels directly from the feed channel 124 to the drain channel 128 without moving along the path through the process chamber 120.

In the shown embodiment the gas passages 130 ensure an almost complete gas removal of process gases.

Although not particularly necessary, due to the effective suction via the gas passages, it is preferred to provide the lance 141 in a direction upside down oppositely as shown in FIG. 2, so that the lance 141 would protrude from the top toward the bottom side of process chamber 120.

This offers the advantage that process gases which travel to the top cannot accumulate at the upper end of the cavity of lance 141, but can be removed at the top side.

A further embodiment of the device according to the invention is shown in FIG. 4 and designated in total with reference numeral 200.

This embodiment is particularly suited for the galvanic treatment of outer surfaces of work pieces 212 which may have a rotationally symmetrical shape or any other suitable shape. In the embodiment shown the work piece 212 may be a hollow cylindrical body the outer wall of which carries an annular groove which forms the treatment surface 214.

The device 200 comprises a first lower clamping part 216 and a second upper clamping part 218 which can be moved relatively to each other in the direction of double arrow 250 by a suitable drive means, such as by a fluid cylinder. Between the upper clamping part and the lower clamping part an intermediate part 224 is provided through which the process fluid can be fed and removed.

For holding and centering the work piece 212 a first upper intermediate ring 220 is provided which rests against the upper clamping part 218. In addition, a second intermediate ring 222 which rests against the lower clamping part 216 is provided. The two intermediate rings 226, 222 serve for centering the work piece 212.

Between the intermediate part 224, the upper intermediate ring 220 and the lower intermediate ring 222 an annular-shaped mask 226 made of metal is held which encloses the treatment surface 214 in an annular manner and which is designed as an electrode 240 connected to a power source by means of a line 242. The other parts are made of electrically insulating material.

The process fluid is fed via a process feed line 244 into an annular-shaped feed distributing channel 233 provided in the mask 226, then travels via feed channels 232 designed as radial slits, into the process chamber 230 and is removed by adjacent drain channels 234 from the process chamber 230. The process fluid then travels into an annularly-shaped drain distribution channel 235 provided in the mask 226.

The drain distribution channel 235 is connected to a suction pump 248 by means of a suitable connecting line 246 for removing process fluid which travels in a closed loop.

In the case of anodic oxidation the work piece 212 is connected to the positive pole of a DC power source via connecting line 238, while the electrode 240 is connected to the negative pole of the DC power source via a connecting line 242.

For ease of representation sealings necessary for sealing the process chamber are not shown in the embodiment according to FIG. 4.

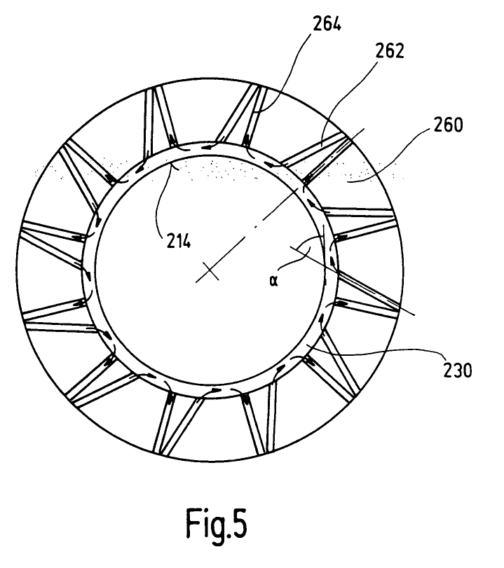

In FIG. 5 a mask according to a further modification is shown in the top view and designated in total with numeral 260. From FIG. 5 a special angular arrangement of feed and drain channels 262, 264 with respect to the treatment surface 214 can be seen. The feed channels 262 do not run into the process chamber 230 perpendicularly, but extend at an acute angle α with respect to the treatment surface 214. The angle α may for instance be on the order of 60°.

By contrast the drain channels 264 extend substantially perpendicularly from the treatment surface 214.

This arrangement serves to effect a certain angular momentum of the process fluid so that the process fluid emerges from the feed channels 262 primarily in tangential direction of the treatment surface 214 and is removed at a short distance thereafter via the drain channels 264 in radial direction of the treatment surface 214.

Such a geometry serves to improve the evenness of the treatment in particular at very tight geometrical conditions such as encountered in the treatment of an outer annular groove.

When utilizing an embodiment according to FIG. 4 e.g. 100 to 1000 l/h of process fluid may be fed through the process chamber, wherein Reynolds' numbers of more than 5000 may be reached. For instance a hard chromium-plating may be performed at 70° C. with 80 to 200 amp/dm².

1. A device for the galvanic surface treatment of work pieces comprising:
a holder for receiving a work piece, said holder comprising a least a first part and a second part;
means for moving at least one of said first and second parts relative to another one of said first and secnd parts between an open position and a closed position, allowing an insertion and removal of said work piece between said first and second parts when being in said open position and forming a closed process chamber comprising at least one exposed surface of said work piece to be treated when being in said closed position;
a plurality of inlet openings provided within said holder for feeding process fluid into said process chamber;
a plurality of outlet openings provided within said holder for removing process fluid from said process chamber;
at least one electrode arranged in fluid communication with said process chamber and having at least one surface exposed toward said process chamber;
means for connecting said electrode to one pole of a DC power source;
means for connecting said work piece to another pole of said DC power source;
a fluid pump for generating a flow of process fluid through said process chamber along a surface of said work piece to be treated;
wherein said inlet openings and outlet openings are arranged in a pattern formed by alternating inlet openings and outlet openings yielding into said closed process chamber.

2. A device for the galvanic surface treatment of work pieces comprising:
a holder for receiving a work piece, said holder comprising a least a first part and a second part;
means for moving at least one of said first and second parts relative to another one of said first and second parts between an open position and a closed position, allowing an insertion and removal of said work piece between said first and second parts when being in said open position and forming a closed process chamber comprising at least one exposed surface of said work piece to be treated when being in said closed position;
a plurality of inlet openings provided within said holder for feeding process fluid into said process chamber;
a plurality of outlet openings provided within said holder for removing process fluid from said process chamber;
at least one electrode arranged in fluid communication with said process chamber and having at least one surface exposed toward said process chamber;
means for connecting said electrode to one pole of a DC power source;
means for connecting said work piece to another pole of said DC power source;
a fluid pump for generating a flow of process fluid through said process chamber along a surface of said work piece to be treated;
wherein said inlet openings and outlet openings are arranged in a pattern formed by alternating groups of inlet openings and outlet openings yielding into said closed process chamber.

3. A device for the galvanic surface treatment of work pieces comprising:
a holder for receiving a work piece having a cavity comprising at least one surface to be treated, said holder comprising a least a first part and a second part;
means for moving at least one of said first and second parts relative to another one of said first and second parts between an open position and a closed position, allowing parts insertion and removal of said work piece into and out of said holder when being in said open position and forming a closed process chamber comprising at least one exposed surface of said work piece to be treated when being in said closed position;
a tube protruding through one of said first and second parts into said cavity and forming said process chamber at least between said exposed surface of said work piece and an outer surface of said tube, said tube comprising at least one electrically conductive part, at least one feed channel and at least one drain channel extending longitudinally therein;
a plurality of inlet openings provided within an outer surface of said tube and communicating with said feed channel for feeding process fluid into said process chamber;
a plurality of outlet openings provided within said outer surface of said tube and communicating with said drain channel for removing process fluid from said process chamber;
means for connecting said electrically conductive part of said tube to one pole of a DC power source;
means for connecting said work piece to another pole of said DC power source;
a fluid pump for generating a flow of process fluid through said process chamber along a surface of said work piece to be treated;
wherein said inlet openings and outlet openings are arranged within a pattern formed by alternating groups of inlet openings and outlet openings.

4. The device of claim 3, wherein said tube comprises a wall extending longitudinally therein and dividing said tube into said feed channel and into said drain channel.

5. The device of claim 3, further comprising gas passages extending between said feed channel and said drain channel.

6. The device of claim 3, further comprising a cover made of insulating material enclosing said tube.

7. The device of claim 3, wherein said inlet openings and said outlet openings have a cross section selected from the group formed by circular, elliptical, oval and rectangular.

8. The device of claim 1, wherein said first and second parts comprise surfaces shaped for resting against end surfaces of said work piece for clamping said work piece there between.

9. The device of claim 8, further comprising a mask surrounding an outer surface of said work piece, wherein said process chamber is formed at least between an outer surface of said work piece and a surface of said mask facing said work piece.

10. The device of claim 9, wherein said inlet and outlet openings are connected to feed and drain channels extending through said mask.

11. The device of claim 9, wherein said mask further comprises an electrode arranged radially distant from said work piece.

12. The device of claim 11, wherein said inlet and outlet openings are connected to feed and drain channels extending through said electrode.

13. The device of claim 9, further comprising first and second intermediate rings resting against said first and second parts and enclosing said mask at a top and bottom side thereof.

14. The device of claim 10, further comprising an outer part surrounding said mask and comprising channels communicating with said feed and drain channels for feeding fluid to said inlet openings and draining fluid from said outlet openings.

15. The device of claim 1, further comprising at least one sealing for sealing said process chamber at least between said work piece, and said first and second parts.

16. The device of claim 1, wherein said inlet openings and said outlet openings have a cross section selected from the group formed by circular, elliptical, oval and rectangular.

17. The device of claim 1, wherein said electrode is arranged outside the process chamber but in fluid communication with feed channels for feeding fluid to said inlet openings.

18. The device of claim 1, wherein said inlet openings communicate with feed channels that run into the process chamber substantially perpendicularly to the surface of the work piece to be treated.

19. The device of claim 1, wherein said inlet openings communicate with feed channels that run into the process chamber at an acute angle with respect to the surface of the work piece to be treated.

20. The device of claim 19, wherein said outlet openings communicate with drain channels that extend from the process chamber substantially perpendicularly with respect to the surface of the work piece to be treated.

21. The device of claim 2, wherein said inlet openings and said outlet openings have a cross section selected from the group formed by circular, elliptical, oval and rectangular.

22. The device of claim 2, wherein said first and second parts comprises surfaces shaped for resting against end surfaces of said work piece for clamping said work piece there between.

23. The device of claim 22, further comprising a mask surrounding an outer surface of said work piece, wherein said process chamber is formed at least between an outer surface of said work piece and a surface of said mask facing said work piece.

24. The device of claim 23, wherein said inlet and outlet openings are connected to feed and drain channels extending through said mask.

25. The device of claim 24, wherein said mask further comprises an electrode arranged radially distant from said work piece.

26. The device of claim 23, wherein said inlet and outlet openings are connected to feed and drain channels extending through said electrode.

27. The device of claim 23, further comprising first and second intermediate rings resting against said first and second parts and enclosing said mask at a top and bottom side thereof.

28. The device of claim 24, further comprising an outer part surrounding said mask and comprising channels communicating with said feed and drain channels for feeding fluid to said inlet openings and draining fluid from said outlet openings.

29. The device of claim 2, further comprising at least one sealing for sealing said process chamber at least between said work piece, and said first and second parts.

30. The device of claim 2, wherein said inlet openings and said outlet openings have a cross section selected from the group formed by circular, elliptical, oval and rectangular.

31. The device of claim 2, wherein said electrode is arranged outside the process chamber but in fluid communication with feed channels for feeding fluid to said inlet openings.

32. The device of claim 2, wherein said inlet openings communicate with feed channels that run into the process chamber substantially perpendicularly to the surface of the work piece to be treated.

33. The device of claim 2, wherein said inlet openings communicate with feed channels that run into the process chamber at an acute angle with respect to the surface of the work piece to be treated.

34. The device of claim 33, wherein said outlet openings communicate with drain channels that extend from the process chamber substantially perpendicularly with respect to the surface of the work piece to be treated.

35. The device of claim 2, wherein said inlet openings and said outlet openings have a cross section selected from the group formed by circular, elliptical, oval and rectangular.

36. A device for the galvanic surface treatment of work pieces comprising:
a holder for receiving a work piece having a cavity comprising at least one surface to be treated, said holder comprising a least a first part and a second part;
means for moving at least one of said first and second parts relative to another one of said first and second parts between an open position and a closed position, allowing an insertion and removal of said work piece into and out of said holder when being in said open position and forming a closed process chamber comprising at least one exposed surface of said work piece to be treated when being in said closed position;
a tube protruding through one of said first and second parts into said cavity and forming said process chamber at least between said exposed surface of said work piede and an outer surface of said tube, said tube comprising at least one electrically conductive part, at least one feed channel and at least one drain channel extending longitudinally therein;
a plurality of inlet openings provided within an outer surface of said tube and communicating with said feed channel for feeding process fluid into said process chamber;
a plurality of outlet openings provided within said outer surface of said tube and communicating with said drain channel for removing process fluid from said process chamber;
means for connecting said electrically conductive part of said tube to one pole of a DC power source;
means for connecting said work piece to another pole of said DC power source;
a fluid pump for generating a flow of process fluid through said process chamber along a surface of said work piece to be treated;
wherein said inlet openings and outlet openings are arranged alternatingly with each other.

37. The device of claim 36, wherein said electrode is arranged radially distant from said process chamber.

38. The device of claim 36, wherein said inlet and outlet openings are connected to feed and drain channels extending through said electrode.

39. The device of claim 36, wherein said inlet and outlet openings are connected to feed and drain channels extending through said mask.

40. A device for the galvanic surface treatment of work pieces comprising:
a holder for receiving a work piece, said holder comprising a mask made of an electrically insulating material surrounding an outer surface of said work piece, and further comprising a least a first part and a second part;
means for moving at least one of said first and second parts relative to another one of said first and second parts for forming a closed process chamber when resting against said work piece and said mask;
a plurality of inlet openings provided within said holder for feeding process fluid into said process chamber;
a plurality of outlet openings provided within said holder for removing process fluid from said process chamber;
at least one electrode arranged in fluid communication with said process chamber;
means for connecting said electrode to one pole of a DC power source;
means for connecting said work piece to another pole of said DC power source;
a fluid pump for generating a flow of process fluid through said process chamber along a surface of said work piece to be treated;
a mask made of an electrically insulating material surrounding an outer surface of said work piece;
wherein
said process chamber is formed at least between an outer surface of said work piece and a surface selected from the group formed by said mask, said electrode, said first part and said second part;
said inlet openings and outlet openings are arranged in a pattern formed by alternating inlet openings and outlet openings yielding into said process chamber and being connected to feed and drain channels extending through at least one part selected from the group formed by said mask and said electrode;
said first and second parts comprise surfaces shaped for resting against end surfaces of said work piece for clamping said work piece and said mask there between.

41. The device of claim 1 wherein said inlet and outlet openings are arranged in a common surface of said holder.

42. The device of claim 2 wherein said inlet and outlet openings are arranged in a common surface of said holder.

43. A device for the galvanic surface treatment of work pieces comprising:
a holder for receiving a work piece having a cavity comprising at least one surface to be treated, said holder comprising a least a first part and a second part;
means for moving at least one of said first and second parts relative to another one of said first and second parts between an open position and a closed position, allowing an insertion and removal of said work piece into and out of said holder when being in said open position and forming a closed process chamber comprising at least one exposed surface of said work piece to be treated when being in said closed position;
a tube protruding through one of said first and second parts into said cavity and forming said process chamber at least between said exposed surface of said work piece and an outer surface of said tube, said tube comprising at least one electrically conductive part, at least one feed channel and at least one drain channel extending longitudinally therein;
a plurality of inlet openings provided within an outer surface of said tube and communicating with said feed channel for feeding process fluid into said process chamber;
a plurality of outlet openings provided within said outer surface of said tube and communicating with said drain channel for removing process fluid from said process chamber;
means for connecting said electrically conductive part of said tube to one pole of a DC power source;
means for connecting said work piece to another pole of said DC power source;
a fluid pump for generating a flow of process fluid through said process chamber along a surface of said work piece to be treated;
wherein said inlet openings and outlet openings are arranged within a pattern formed by alternating groups of inlet openings and outlet openings.

44. A process for the galvanic surface treatment of work pieces within a closed process chamber, comprising the following steps:
clamping the work piece within a holder for forming a closed process chamber through which process fluid is fed, wherein at least one surface of said work piece is exposed to said process chamber;
contacting said work piece and connecting with a DC power source;
arranging at least one electrode at a distance from said work piece:but in fluid communication with said process chamber and connecting to an opposite pole of said DC power source;
feeding process fluid into said process chamber through a plurality of inlet openings arranged at a distance from said exposed surface of said work piece;
removing process fluid from said process chamber through a plurality of outlet openings, wherein said inlet openings and said outlet openings are arranged alternatingly with each other.

45. A process for the galvanic surface treatment of work pieces within a closed process chamber, comprising the following steps:
clamping the work piece within a holder for forming a closed process chamber through which process fluid is fed, wherein at least one surface of said work piece is exposed to said process chamber;
contacting said work piece and connecting with a DC power source;
arranging at least one electrode at a distance from said work piece but in fluid communication with said process chamber and connecting to an opposite pole of said DC power source;
feeding process fluid into said process chamber through a plurality of inlet openings arranged at a distance from said exposed surface of said work piece;
removing process fluid from said process chamber through a plurality of outlet openings, wherein groups of said inlet openings and said outlet openings are arranged alternatingly with each other.

46. The process of claim 44 wherein said inlet and outlet openings are arranged in a common surface of said holder.

47. The process of claim 45 wherein said inlet and outlet openings are arranged in a common surface of said holder.
